(19) United States
(12) Patent Application Publication
(10) Pub. No.: US 2006/0077002 A1
(43) Pub. Date: Apr. 13, 2006

(54) Apparatus and methods for saving power and reducing noise in integrated circuits

(76) Inventor: Richard T. White, Nampa, ID (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/026,997

(22) Filed: Dec. 30, 2004

Related U.S. Application Data
(60) Provisional application No. 60/617,107, filed on Oct. 8, 2004.

(51) Int. Cl. G05F 1/10

(52) U.S. Cl. 327/544

(57) ABSTRACT

The power saving and noise reducing circuit includes a first impedance disposed between a positive voltage supply and a positive voltage terminal of the electronic circuitry, a second impedance disposed between a negative voltage supply and a negative voltage terminal of the electronic circuitry, and a capacitor disposed between the positive voltage terminal and negative voltage terminal of the electronic circuitry, the electronic circuitry operating from a pseudo voltage supply across the capacitor. The impedances may be current sources. High speed switching currents are recirculated to and from the capacitor to save power. Electronic switching noise is also substantially reduced.

### CROSS-REFERENCE TO RELATED APPLICATION

This patent application is a non-provisional patent application of U.S. provisional patent application Ser. No. 60/617,107 filed on Oct. 8, 2004, the right of priority of which is claimed for this patent application.

### BACKGROUND OF THE INVENTION

This invention generally relates to semiconductor integrated circuits. More particularly, the present invention relates apparatus and methods for substantially reducing power used by integrated circuits and substantially reducing electronic noise caused by high speed switching. This invention further relates to reducing or eliminating the cooling requirements for integrated circuits.

Semiconductor integrated circuits using CMOS transistors are built with conventional logic gates using inverters. Shown in FIG. 1 is such an inverter, generally designated 20. The inverter circuit 20 comprises transistors MP1, a P-channel transistor, and MN1, an N-channel transistor, connected in series between the sources of power Vcc and Vss. In many applications, Vss may be ground instead of a second power supply.

FIG. 2 shows sequential states I, II and III for circuit 20, the input voltage, Vin, of which is initially set illustratively to a low or “0” state. This is illustrated by waveform 24 in FIG. 2. In this state I, the inverter output voltage Vout is high. P-channel transistor MP1 is conductive or on and pulls up the output node voltage Vout to a high level. With the inverter input voltage Vin at a low level, the pulldown N-channel transistor MN1 is off. Waveform 22 illustrates the voltage Vout. During this time, current Ivcc drawn from power source Vcc is zero, as seen in FIG. 3. As switching takes place, such as at time t₁ in FIG. 3, a current Ivcc is conducted through transistors MP1 and MN1 in the form of a spike, as shown in waveform 26. This current Ivcc flows from the supply voltage Vcc to ground. Current Ivcc is “lost” to the silicon substrate on or in which the inverter is formed and is not used in the functioning of the circuit design. This lost current Ivcc is sometimes referred to as crowbar current, switching current or substrate current. In a typical IC design, this switching current cannot be used or recirculated. Instead, it is lost as heat generated by electrons moving to ground or to the power supply Vss.

A general object of the present invention is therefore to provide a system and methods that substantially reduce the power used by an integrated circuit.

Another general object of the present invention to provide a system and methods that substantially reduce the electronic noise generated by an integrated circuit while switching at high speeds.

A further general object or the present invention is to provide a system and methods that substantially reduce or eliminate the cooling requirements for many integrated circuits.

Yet another object of the present invention is to provide a pseudo power supply for an integrated circuit that substantially reduces the power used by the integrated circuit.

A still further object of the present invention is to provide a pseudo power supply for an integrated circuit that substantially reduces the electronic noise generated by the integrated circuit at high switching speeds.

Another object of the present invention is to provide a pseudo power supply for an integrated circuit that recirculates switching currents from the integrated circuit to and from a capacitor to substantially reduce the power used by the integrated circuit.

### SUMMARY OF THE INVENTION

The present invention is directed to a power saving circuit for operation of electronic circuitry that is implemented in CMOS technology between a positive voltage supply and negative voltage supply, or between a positive voltage supply and ground. The electronic circuitry has a positive voltage terminal and a negative voltage terminal or a ground terminal. The power saving circuit includes a first impedance disposed between the positive voltage supply and the positive voltage terminal of the electronic circuitry, a second impedance disposed between the negative voltage supply and the negative voltage terminal of the electronic circuitry, and a capacitor disposed between the positive voltage terminal and negative voltage terminal of the electronic circuitry, such that the electronic circuitry operates from a pseudo voltage supply across the capacitor. High speed switching in the electronic circuitry produces switching currents that are recirculated to and from the capacitor to save power. The negative voltage supply may be ground and the negative voltage terminal of the electronic circuitry may be a ground terminal. The first impedances may be current sources. The electronic circuitry may be a logic circuit, a memory circuit, a microprocessor, a microcontroller, or the like.

The present invention is also directed to such a pseudo power supply for an integrated circuit, including a first impedance disposed between the positive voltage supply and the positive voltage terminal of the electronic circuitry, a second impedance disposed between the negative voltage supply and the negative voltage terminal of the electronic circuitry, and a capacitor disposed between the positive voltage terminal and negative voltage terminal of the electronic circuitry, such that the electronic circuitry operates from a pseudo voltage supply across the capacitor.

The present invention is further directed to methods of saving power by operating electronic circuitry that is implemented in CMOS technology from a pseudo voltage supply, the methods including the steps of providing a first impedance between a positive voltage supply and a positive voltage terminal of the electronic circuitry, providing a second impedance between a negative voltage supply and a negative voltage terminal of the electronic circuitry, providing a capacitor between the positive voltage terminal and the negative voltage terminal of the electronic circuitry to establish a pseudo voltage supply for the electronic circuitry, and recirculating high speed switching currents produced by the electronic circuitry to and from the capacitor to save power. The power used by the electronic circuitry may be reduced by a factor of about 4, or more.

Another aspect of the present invention is to provide methods of reducing electronic noise generated by high speed switching in electronic circuitry that is implemented in CMOS technology, the electronic circuitry having a positive voltage terminal and a negative voltage terminal, the method comprising the steps of providing a first impedance between a positive voltage supply and a positive voltage terminal of the electronic circuitry, providing a second impedance between a negative voltage supply and a negative voltage terminal of the electronic circuitry, and providing a capacitor between the positive voltage terminal and the negative voltage terminal of the electronic circuitry to establish a pseudo voltage supply for the electronic circuitry. High speed switching currents produced by the electronic circuitry are recirculated to and from the capacitor. The electronic noise may reduced by a factor of about 10 to 1, or more.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the several figures in which like reference numerals identify like elements, and in which:

FIG. 1 is a schematic diagram of an inverter formed from two complementary MOS transistors;

FIG. 2 is a graph illustrating typical waveforms for the input voltage and the output voltage for the inverter of FIG. 1;

FIG. 3 is another graph illustrating the input and output voltages for the inverter of FIG. 1 and further illustrating switching currents conducted by the transistors of the inverter when the input and output voltages change state;

FIG. 4 is a schematic diagram illustrating a string of inverters operating from pseudo power supplies formed by transistors arranged between the string of inverters and the power supply and between the string of inverters and ground such that the inverters draw high speed switching currents off of a capacitor, and return high speed switching currents to the capacitor, to save power in accordance with the present invention;

FIGS. 5A and 5B are graphs that illustrate typical waveforms that occur during operation of the inverters of FIG. 4;

FIG. 6 is a schematic diagram illustrating a string of inverters similar to FIG. 4, but operating from a pseudo power supply formed by a single impedance arranged between the string of inverters and the positive power supply such that the inverters draw some high speed switching currents off of a capacitor to save power in accordance with the present invention;

FIG. 7 is a schematic diagram illustrating a string of inverters similar to FIG. 4, but operating from a pseudo power supply formed by a single impedance arranged between the lower pseudo power supply line and ground such that the inverters return high speed switching currents to the capacitor to save power in accordance with the present invention;

FIG. 8 is a schematic diagram of several inverters arranged with feedback to form a ring oscillator that may be substituted for the three inverter stages in the schematic diagram of FIG. 4 for similar power savings;

FIG. 9 is a graph illustrating a typical voltage output waveform for the ring oscillator of FIG. 8 when operating directly between a voltage supply and ground;

FIG. 10 is a graph illustrating typical current drain for the ring oscillator of FIG. 8 when operating directly between a voltage supply and ground;

FIG. 11 is a graph illustrating a typical voltage output waveform for the ring oscillator of FIG. 8 when operating from the pseudo power supplies of FIG. 4;

FIG. 12 is a graph illustrating a typical current drain for the ring oscillator of FIG. 8 when operating from the pseudo power supplies of FIG. 4;

FIG. 13 is a schematic diagram, partially in block diagram format, of a typical memory circuit;

FIG. 14 is a schematic diagram of the memory circuit of FIG. 13, with portions of the memory circuit operating from the pseudo power supplies of the present invention;

FIG. 15 is a schematic diagram of the memory circuit or FIG. 13, with all portions of the memory circuit operating from the pseudo power supplies of the present invention;

FIG. 16 is a schematic diagram of a memory circuit with differential outputs and operating from the pseudo power supplies of the present invention;

FIG. 17 is a graph illustrating a typical voltage waveforms for a typical memory cell within the memory circuit of FIGS. 14, 15 or 16 when operating from the pseudo power supplies of the present invention;

FIG. 18 is a graph illustrating a typical current drain for a typical memory cell within the memory circuit of FIGS. 14, 15 or 16 when operating from the pseudo power supplies of the present invention;

FIG. 19 is a graph illustrating typical current drain for a typical memory cell within the memory circuit of FIGS. 14, 15 or 16 when operating directly between a voltage supply and ground; and

FIG. 20 is a schematic diagram, partially in block diagram format, of a microprocessor with certain portions of the microprocessor operating from the pseudo power supplies of the present invention.

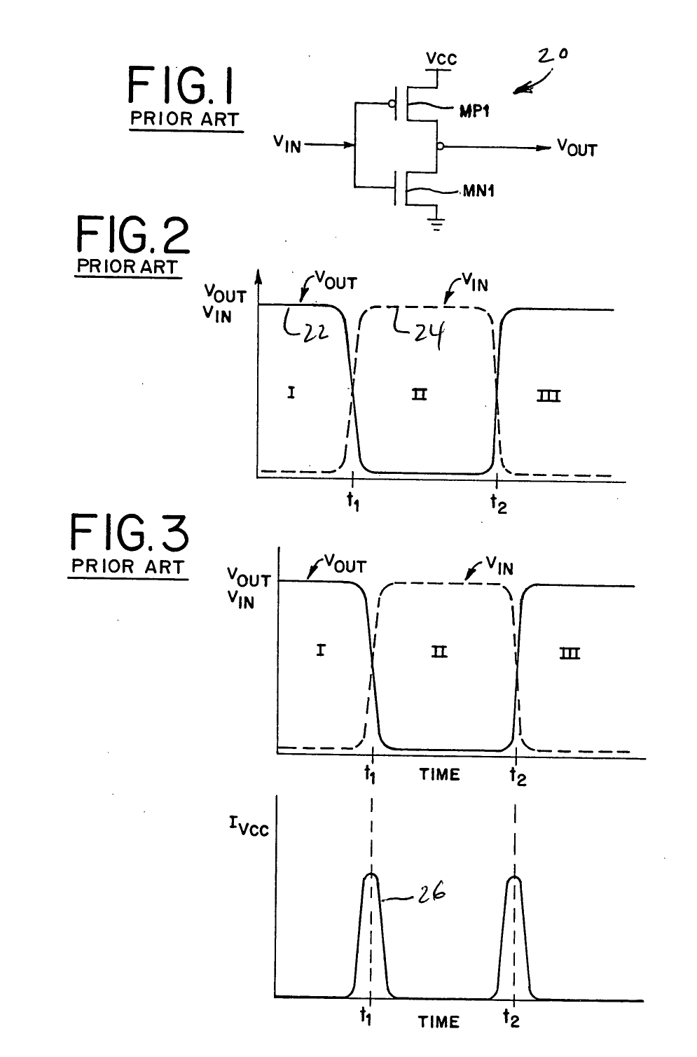

### DESCRIPTION OF THE PREFERRED EMBODIMENTS OF THE INVENTION

As discussed above, in prior art IC designs with semiconductors switching at high speed, switching currents are typically lost to the substrate. These lost switching currents result in potentially significant power consumption. The attendant heat generated by the power consumption may require that further measures be taken to cool the IC.

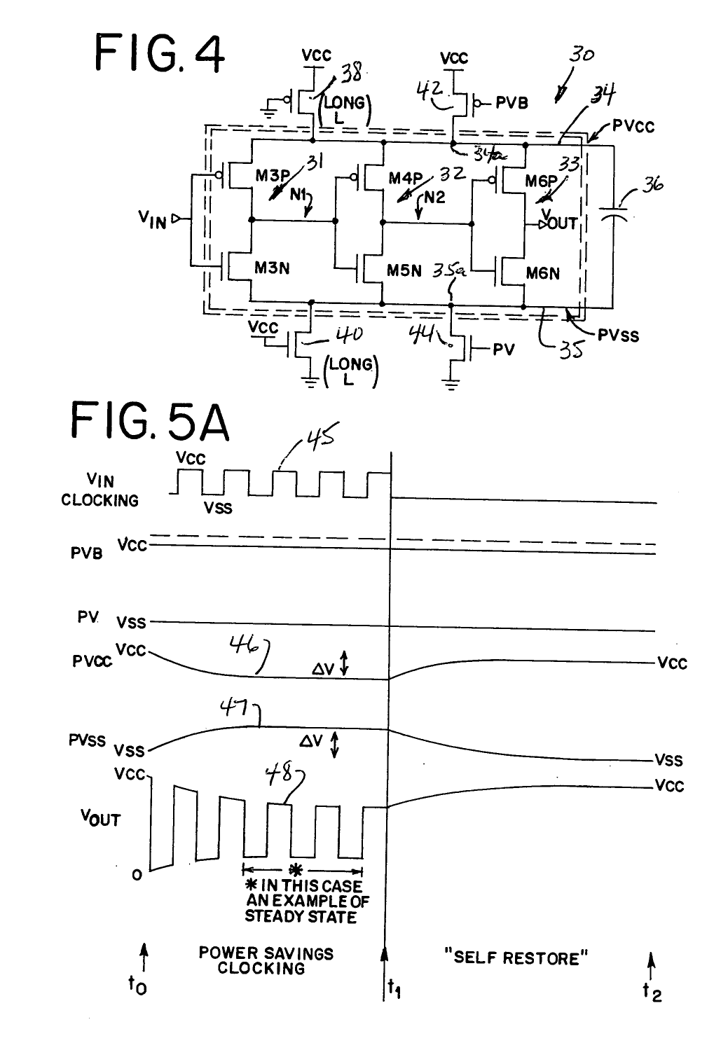

However, in accordance with the present invention, these switching currents are recirculated, or captured, by one or more capacitors, rather than being lost to the substrate. That is, depending upon the polarity of the switching, the switching current may be supplied to the capacitor, or the switching current may be drawn off of the capacitor. An example is shown in the circuit schematic of FIG. 4. The logic circuit, generally designated 30, shown in FIG. 4 includes, three CMOS inverters 31-33 arranged in series with each other and in parallel with a capacitor 36 between an upper power supply rail 34 and a lower power supply rail 35. The logic circuit, including inverters 31-33, could illustratively be any type of logic, such as NOR, NAND, etc. The example shown in FIG. 4 is a reversible string of inverters with recirculated switching currents.

In the circuit of FIG. 4, switching currents are recirculated to and from capacitor 36 rather than being lost to the substrate, as occurred in the example of FIG. 1. The location of capacitor 36 can either be on the semiconductor chip or off. PVcc is a positive pseudo or virtual power supply on power rail 34 that is derived from or related to the supply voltage Vcc. PVss is a negative pseudo power supply or virtual ground at power rail 35 that is related to or associated with the ground potential, or that may be associated with a negative power supply Vss.

Transistors 38 and 40 in FIG. 4 may have long channel lengths to keep the positive pseudo voltage supply PVcc on pseudo power supply rail 34 at or near Vcc and the negative pseudo voltage supply PVss on pseudo power supply rail 35 at or near Vss (or ground) during the quiescent or non-switching state of the logic circuit. Transistors 38 and 40 may operate as current sources and provide relatively high impedance between the respective power supplies Vcc and Vss and the respective virtual or pseudo power supplies PVcc and PVss. Thus, the switching currents are recirculated by, or captured by, capacitor 36 instead of being lost to the substrate. Essentially, the positive pseudo power supply PVcc supplies a trickle charge to the inverter gates 31-33 and the dynamic high speed switching currents are drawn off of, or supplied to, capacitor 36. Thus, the trickle charge need only be in an amount that keeps the circuit biased for operation.

Alternatively, weakly biased transistors or large resistors could be used in place of transistors 38 and 40 to achieve the same or similar objectives. More generally, transistors 38 and 40 could be impedances that provide sufficient isolation at the switching speeds of interest between the positive and negative voltage supplies Vcc and Vss and the pseudo voltages PVcc and PVss, such that most or a substantial portion of the switching currents are drawn off of, or returned to, capacitor 36 rather than being lost to the substrate. Transistors 42 and 44 may be used to more rapidly and actively pre-charge the bus, including capacitor 36, for a limited number of cycles, such as during power-up of the circuit 30. Of course, transistors 38, 40, 42 and 44 could be fabricated on the same semiconductor chip as the circuit of FIG. 4 such that the entire circuit of FIG. 4 is packaged within the integrated circuit. Alternatively, capacitor 36 may be an external element or fabricated on the semiconductor chip. Along these lines, a pseudo power supply consisting of transistors 38, 40, 42 and 44, with or without capacitor 36, could be separately fabricated and supplied for use with integrated circuits, such as for the simplified example of inverters 31-33 in the example of FIG. 4. Other larger ICs will, of course, typically require greater amounts of bias current to remain active, and the transistors 38, 40, 42 and 44 may be designed to provide the required amount of bias current.

In the embodiment shown in FIG. 4, the transistors 38 and 42 may be described as disposed between positive power supply Vcc and a first node 34a and transistors 40 and 44 may similarly be described as being disposed between a second node 35a and the negative power supply Vss (or ground). Likewise, positive pseudo voltage supply PVss may be described as at first node 34a, negative pseudo voltage supply PVcc as at second node 35a, capacitor 36 as disposed between the first and second nodes 34a and 35a, and the electronic circuitry consisting of inverters 31-33 also disposed between nodes 34a and 35a.

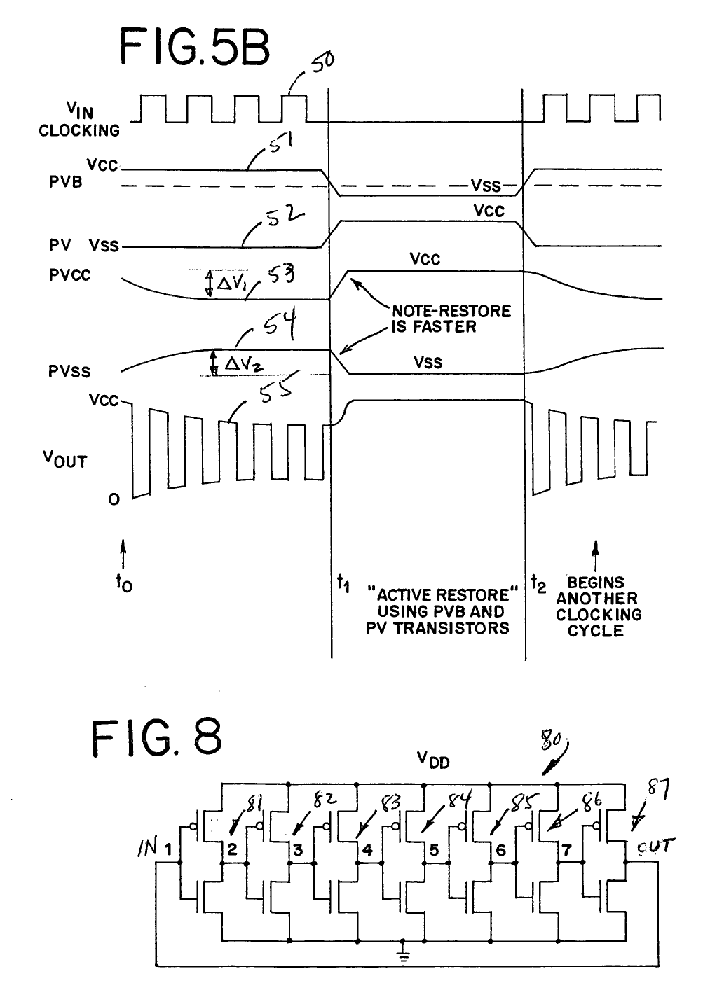

FIGS. 5A and 5B illustrate various typical waveforms that may be present in the circuit of FIG. 4 while clocking the circuit. FIG. 5A illustrates a self-restore mode and FIG. 5B illustrates an active restore mode. In the self-restore example of FIG. 5A, as the clocking of the input Vin begins at time t₀, as shown in waveform 45, pseudo power supply voltages PVcc and PVss are initially near the respective supply voltages Vcc and Vss but begin decaying toward their respective steady state values. Thus, positive pseudo supply voltage PVcc decays toward a value that is ΔV less than the positive voltage supply VCC, as shown in waveform 46, and the negative pseudo supply voltage PVss decays toward a value that is ΔV greater than the negative voltage supply Vss, as shown in waveform 47. Typically, the pseudo supply voltages PVcc and PVss will arrive at their steady state values within a few to several clock cycles. Similarly, the output signal Vout will follow the envelopes formed by the pseudo power supplies Vss and Vcc as shown in waveform 48. That is, the amplitude of output signal Vout will initially approximate the difference between the positive power supply Vcc and the negative power supply Vss, which is assumed to be ground in this example. However, within a few to several clock cycles, the amplitude of output signal Vout will be bounded by the pseudo power supplies PVcc and PVss.

When clocking of the Vin terminal ceases at time t₁ in waveform 45 of FIG. 5A, transistors 38 and 40 continue to conduct and gradually restore the pseudo voltage supplies PVcc and PVss on the voltage supply rails 34 and 35 toward the respective supply voltages Vcc and Vss, as shown in waveforms 46 and 47. The active restore transistors 42 and 44 do not assist in the restoration of the pseudo supply voltages Vcc and Vss in the example of FIG. 5A since the bias voltages PVB and PV at the gates of the transistors 42 and 44 remain unchanged. That is, bias voltage PVB remains near the positive supply voltage Vcc and the bias voltage PV remains near negative supply voltage Vss keeping transistors 42 and 44 in nonconductive states. Thus, the self-restore mode in FIG. 5A is comparatively slow, as compared to the active restore mode shown in FIG. 5B, and is automatically achieved by continued conduction of transistors 38 and 40.

FIG. 5B shows the active restore mode in which the active restore transistors 42 and 44 in FIG. 4 are rendered conductive by driving the gate terminal of transistor 42 low and by driving the gate terminal of transistor 44 high, such as at time t₁ in FIG. 5B, using active signals PVB in waveform 51 for transistor 42 and PV in waveform 52 for transistor 44. This quickly drives the positive pseudo supply voltage PVcc (waveform 53) on the upper voltage supply rail 34 toward the positive supply voltage Vcc and drives the negative pseudo supply voltage PVss (waveform 54) on the lower voltage supply rail 35 toward the negative supply voltage Vss. Of course, depending upon the circuit requirements, the negative supply voltage Vss may be any potential that is less than the positive supply voltage PVss, such as ground rather than a negative supply voltage. When the clocking resumes at time t₂ in FIG. 5B, the positive pseudo supply voltage PVcc, waveform 53, and negative pseudo supply voltage PVss, waveform 54, gradually return to their normal operative values, which may occur within a few clock cycles.

It can be seen that the pseudo power supply voltages on the upper and lower voltage supply rails 34-35, PVss and PVcc, drift between different voltage levels in both FIGS. 5A and 5B, depending upon whether circuit 30 is switching or is at rest. It can also be appreciated that the power savings are about 50% since charge is being recirculated half of the time:
P=½CV²f,
where P is the power, C is the capacitance of capacitor 36, V is the potential between the pseudo power supplies PVss and PVcc and f is the frequency. Thus, if
f=f/2,
then the power saved is:
P=½CV²f/2

Since the power saved is directly proportional to the capacitive value of the capacitor, it can be further appreciated that, given a large enough capacitance, power savings of 10 times or 1000 times are feasible with capacitors of larger capacitive values. In addition, these savings can be implemented with little or no degradation in clocking or operational speed of the circuit. For example, for smaller circuits, such as that shown in FIG. 4, typical on chip capacitances may be in the range of about 1 pf to hundreds of nf, which is sufficient to implement charge recovery in accordance with the present invention in many instances, particularly with fewer transistors. Moreover, if the ΔV drop in the bus is limited to about a volt or less, then the speed of switching transistors is virtually unaffected. For example, the upper voltage supply rail 34 may drop by about a volt or less and the lower voltage supply rail 35 may raise by about 0.5 volts in a typical voltage supply arrangement where Vcc is about 5 volts and Vss is 0 volts.

As the speed or frequency increases, the power savings also increases. If the switching speed is increased, the switching or crowbar currents become a larger percentage of the overall power used. Yet another factor in the power savings is the reduction in voltage applied to the switching circuit due to the lower voltage between the pseudo power supplies PVcc and PVss as compared to the voltage between the power supply Vcc and ground. Note that this ΔV occurs on both sides of the inverter gates in FIG. 4 as the difference between Vcc and PVcc (ΔV₁) and as the difference between PVss and Vss (ΔV₂), where the total difference between power supplies Vss and Vcc and the pseudo power supplies PVss and PVcc is ΔV=ΔV₁+ΔV₂. As can be seen from the power equation above, power saved will increase with the square of the voltage. As an example, if Vcc is 5 volts and the difference between PVcc and PVss is 4 volts, the power reduction is 9/25 or 36 percent. Many lower voltage logic circuits and microprocessors are currently available that operate in the 2 to 3 volt range. As another example, if Vcc is 3 volts and the potential difference between PVcc and PVss is 2 volts, the power reduction is 5/9 or about 55 percent. Taking all of these power reduction considerations into account, power reductions on the order of 75 percent and greater can be realistically achieved.

In summary, the power saved can also be shown to be
P=P_{C}+P_{D}+P_{L}
where P_{C} is the crowbar or switching current during switching, P_{D} is the power dissipated in charging the gate capacitance and the parasitic capacitance and P_{L} is the leakage power in the non-switching state. In older integrated circuit technologies, the crowbar power P_{C} represents about 20 to 30 percent of the total power and the power P_{D} represents about 60 to 70 percent of the total power. However, in the newer integrated circuit technologies, such as about 90 nm, the crowbar power P_{C} and the charging power P_{D} are about the same, i.e., both about 45 percent. Thus, the crowbar current is becoming increasingly important. The power P_{L} is typically less, such as about 10 percent, since it depends upon the leakage current and the ΔV between the pseudo power supply voltages PVcc and PVss and the respective supply voltages Vcc and Vss. Depending upon transistor sizing and bias, the voltage and frequency may also modulate to provide still further energy savings.

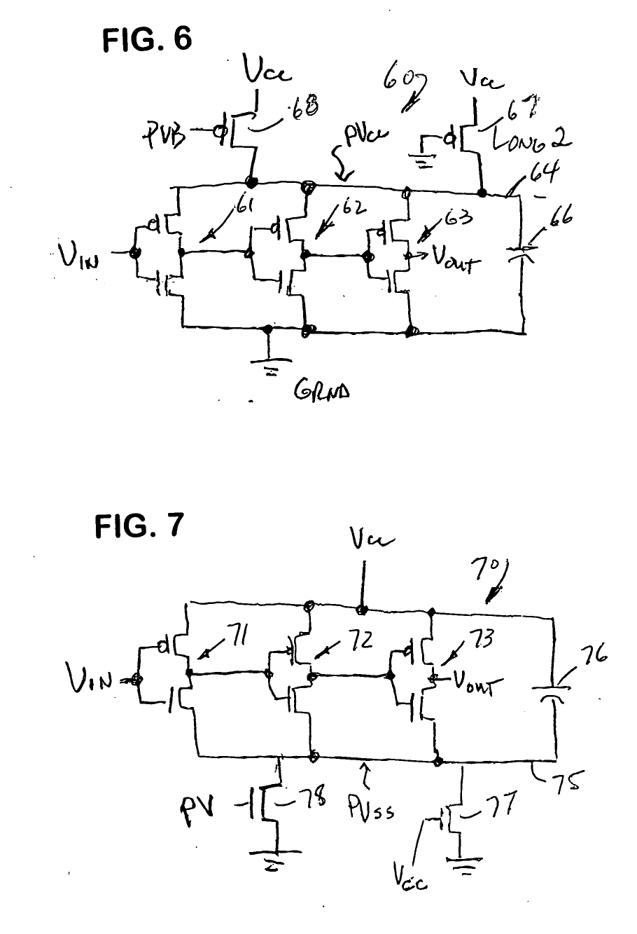

Another embodiment of the logic circuit 30 of FIG. 4 is shown in FIG. 6. In this embodiment, a logic circuit, generally designated 60 includes inverters 61, 62 and 63. Unlike the circuit 30 in FIG. 4, which has impedances or current sources in the form of transistors 38 and 40 to create two pseudo power supply rails 34 and 35 in that example, circuit 60 in FIG. 6 has a single impedance or current source in the form of transistor 67 in this example. There is no equivalent to transistor 40 in FIG. 4, and there is therefore no lower pseudo power supply rail equivalent to pseudo voltage supply rail 35 in FIG. 4. Circuit 60 thus operates with a single impedance 67 instead of the dual impedances 38 and 40 of FIG. 4. Thus, impedance 67 provides a degree of isolation between voltage supply Vcc and pseudo voltage supply PVcc on rail 64 that will cause switching currents to be drawn off of capacitor 66. However, some switching currents will be sunk to ground because there is no isolation between circuit 60 and ground. Thus, circuit 60 will recirculate some switching currents relative to capacitor 66, but not as effectively as most of the switching currents in circuit 30 of FIG. 4. As previously described in FIG. 4, transistor 68 has a gate terminal that is biased to keep it nonconductive. However, if the gate bias is switched to a lower potential, such as to near ground or near the negative supply voltage Vss as shown in waveform 51 of FIG. 5B, transistor 68 will become conductive to actively restore the pseudo voltage supply rail 64 toward the supply voltage Vcc.

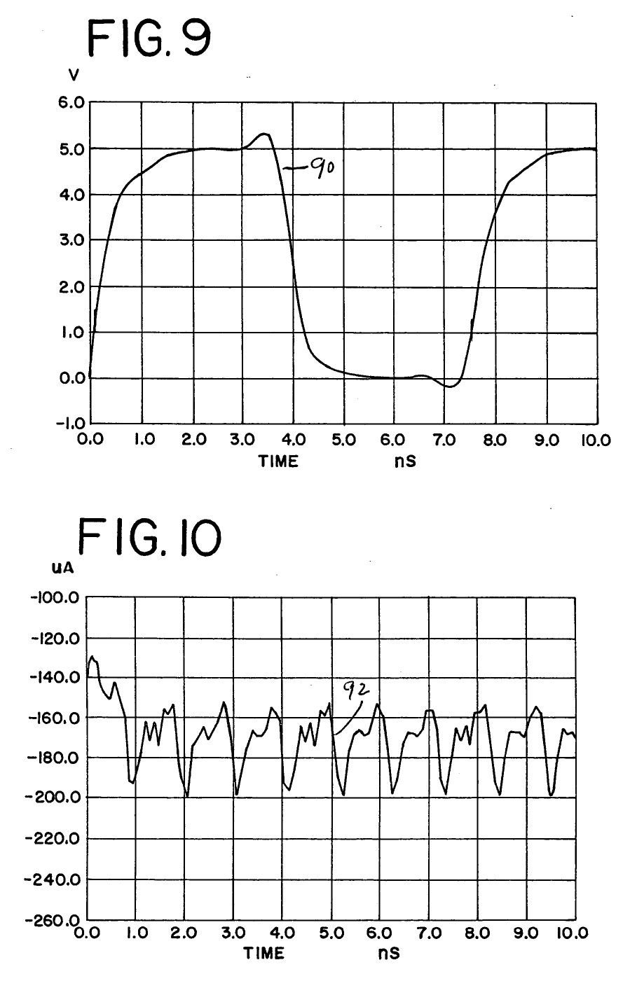

Yet another embodiment of the logic circuit 60 of FIG. 6 that utilizes the single impedance approach is shown in FIG. 7. In this embodiment, a logic circuit, generally designated 70 includes inverters 71, 72 and 73. Circuit 70 in FIG. 7 has a single impedance or current source in the form of transistor 77 disposed between the lower pseudo power supply rail 65 and ground. Of course, transistor 77 may be disposed between the lower power supply rail 65 and a negative voltage supply Vss, if a negative voltage supply is utilized. In circuit 70, there is no equivalent to transistor 38 in FIG. 4, and there is therefore no upper pseudo power supply rail PVcc equivalent to the pseudo voltage supply rail 34 in FIG. 4. Circuit 70 thus operates with a single impedance 77 instead of the dual impedances 38 and 40 of FIG. 4. Thus, impedance 77 provides a degree of isolation between ground (or voltage supply Vss) and the lower pseudo voltage supply PVss on rail 75 that will cause switching currents to be drawn off of capacitor 76. However, some switching currents will be drawn off of positive voltage supply Vcc, rather than capacitor 76, because there is no isolation between circuit 70 and positive voltage supply Vcc. Thus, circuit 70 will recirculate some switching currents relative to capacitor 76, but not as effectively as most of the switching currents in circuit 30 of FIG. 4. As previously described in FIG. 4, transistor 78 has a gate terminal that is biased to keep it nonconductive. However, if the gate bias is switched to a higher potential, such as to near the positive voltage supply Vcc as shown in waveform 52 of FIG. 5B, transistor 78 will become conductive to actively restore the pseudo voltage supply rail 75 toward ground or toward the negative supply voltage Vss.

FIG. 8 illustrates a ring oscillator, generally designated 80, formed from seven inverter stages, generally designated 81-87, connected in series. Inverter stages 81-87 may each be similar to inverter stage 20 illustrated in FIG. 1. This ring oscillator 80 can, of course, be inserted in place of the inverter stages 31-33 in FIG. 4 between the pseudo power supplies PVcc and PVss on the pseudo power supply rails 34 and 35, instead of between a voltage supply Vdd and ground as indicated in FIG. 8. Capacitor 36 could also be connected between the pseudo power supplies as in FIG. 4. Ring oscillator 80 will then also benefit from the increased power savings and reduced heat dissipation as previously described for inverters 31-33 in FIG. 4.

FIGS. 9 and 10 illustrate graphs from a computer simulation of the operation of the ring oscillator of FIG. 8, with the ring oscillator operating directly between a supply voltage Vdd of 5 volts and ground. As can be seen from waveform 90 in FIG. 9, the switching period of the output of the ring oscillator is about 7.4 nS, which is equivalent to an operating frequency of about 135 MHz. Waveform 92 in FIG. 10 illustrates the current drain from the voltage supply Vdd, which quickly stabilizes to an average about 175 μA.

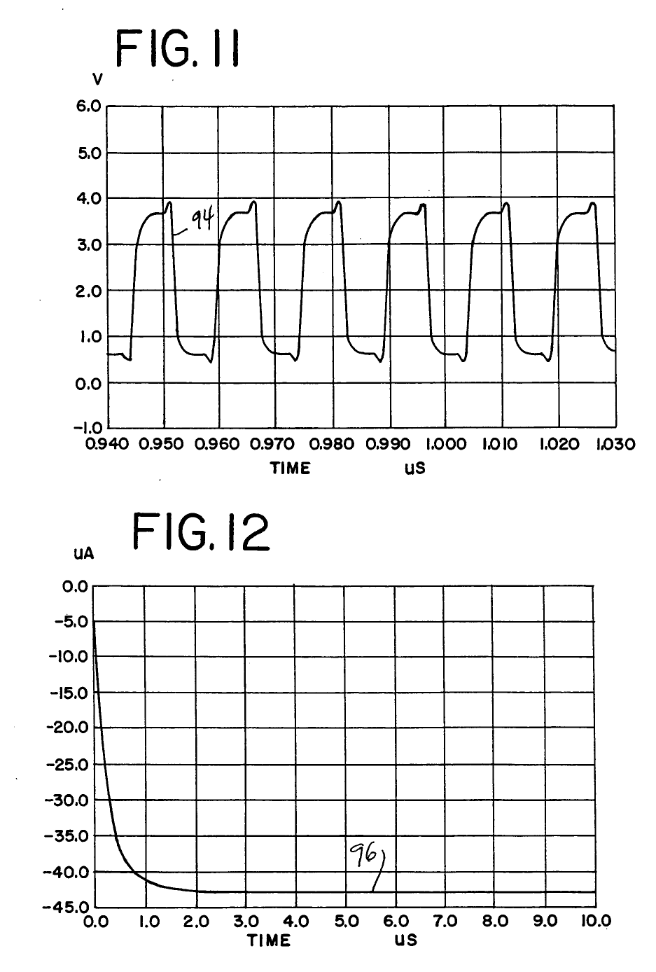

FIGS. 11 and 12 illustrate graphs from a computer simulation of the operation of the ring oscillator 80 of FIG. 8, with ring oscillator 80 operating between virtual or pseudo power supplies in a manner similar to the previously-described circuit 30 in FIG. 4. The capacitor 36 is selected to be 25 pf for this simulation. As can be seen from waveform 94 in FIG. 11, the switching period of the output of the ring oscillator is about 0.015 μS or about 15 nS, which is equivalent to an operating frequency of about 67 MHz. In this simulation, the pseudo voltage supplies PVcc and PVss are about 4.0 volts and 0.5 volts, respectively where Vcc is 5.0 volts and Vss is 0 volts (or ground).

FIG. 12 illustrates that the current drain from the voltage supply Vcc quickly stabilizes at about 43 μA of steady state current, which is also about 25 percent of the 175 μA current drain for operation of the ring oscillator 80 directly between the power supply Vdd and ground, as shown in FIGS. 9 and 10. Stated conversely, operation of the ring oscillator 80 between the virtual power supplies PVcc and PVss, as in FIG. 4, saves about 75 percent of the power as compared to operation of ring oscillator 80 directly between the supply voltage Vdd and ground. Note also that the current drain from the virtual power supply PVcc quickly stabilizes near the final value within about one μS or several clock cycles.

The present invention also significantly reduces electromagnetic interference (EMI) as can be seen in comparing FIGS. 9 and 10 with FIGS. 11 and 12. First, comparing FIGS. 9 and 11, the voltage transients are without the invention in FIG. 9 are between about 5 and 0 volts; for a range of 5.0 volts. The voltage transients with the invention in FIG. 11 are between about 4.0 to 0.5 volts, for a range of about 3.5 volts. The current transients are even more pronounced as can be seen by comparing FIGS. 10 and 12. In FIG. 10, current transients without the invention are between about 155 and 200 μA; for a range of about 45 μA. In FIG. 12, current transients are virtually undetectable due to the recirculating of switching currents by capacitor 36.

It will be readily appreciated by those skilled in the art that the above described techniques for saving power in smaller circuits, such as the gate of FIG. 4 or the ring oscillator of FIG. 8 can be expanded to larger integrated circuits, such as microprocessors, microcontrollers, digital signal processors (DSPs) and the like, for even greater power savings. Of course, when microprocessors or other more complex ICs are designed in accordance with the present invention, they may have circuitry that is internally subdivided into smaller sections, each with its own capacitor 36 or equivalent. Furthermore, since power dissipation due to switching currents is largely eliminated in accordance with the present invention, apparatus frequently used to cool microprocessors may be substantially reduced in size, or completely eliminated. Thus, devices that utilize a microprocessor or the like may be made smaller in size and more economically.

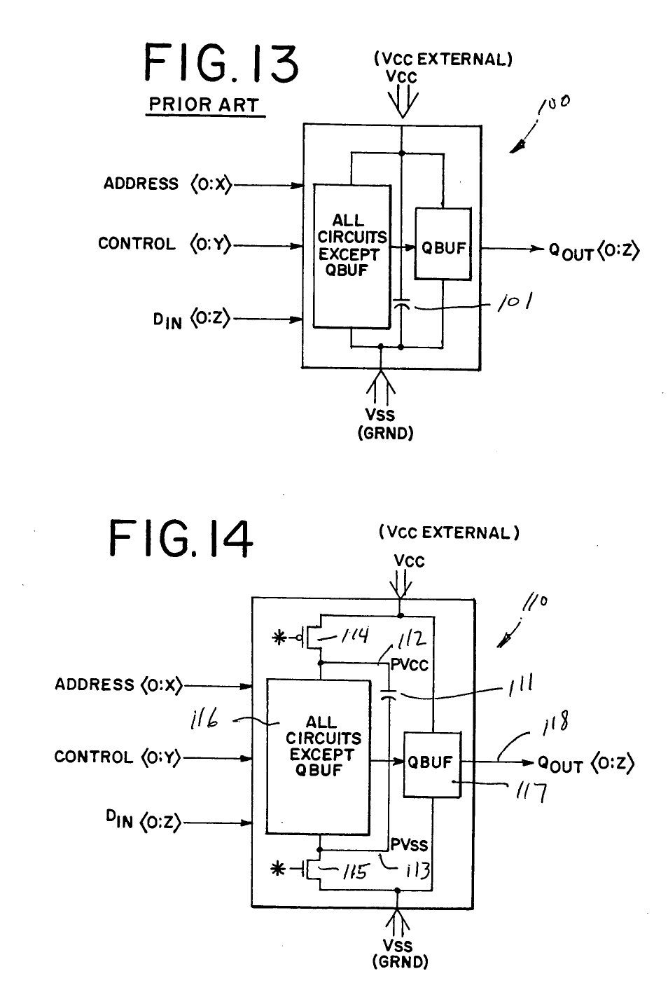

The present invention also has applicability to memory technologies, including memory circuits and memory devices. For example, flash memory, EEProm, EProm, ROM, DRAM, SDRAM, SRAM and FERAM memory technologies may all achieve substantial power savings. FIG. 13 illustrates a typical prior art memory circuit, generally designated 100. In this example, a filter capacitor 101 is connected between a positive supply voltage Vcc (or Vcc external) and a negative supply voltage Vss (or ground) on the memory chip. The purpose of capacitor 101 is to reduce the ripple in the voltage Vss supplied to the memory chip when the circuit 100 is active. Of course, all power, including the switching or crowbar currents, comes from the power supply Vcc.

FIG. 14 illustrates a first embodiment of the present invention as applied to a memory circuit, generally designated 110, of the type shown in FIG. 13. In FIG. 14, a capacitor 111 is now disposed between the pseudo power supplies PVcc and PVss on pseudo power supply rails 112 and 113, respectively, with a transistor 114 disposed between positive voltage supply Vss and positive pseudo supply PVss and a transistor 115 disposed between PVss and Vss or ground. Transistors 114 and 115 may have long channel lengths as previously described with respect to FIG. 4 or may comprise other types of biased transistors, resistors or the like. Thus, because of the impedances 114-115 disposed between Vcc and PVcc and between PVss and Vss, respectively, pseudo power supplies PVcc and PVss now become the actual power lines used by most or all of the memory circuit 116 except for the output buffer QBUF 117, and capacitor 111 now supplies the switching or crowbar currents during switching of most of the memory circuit 116. If capacitor 111 continues as the on chip capacitance, such as capacitor 101 in FIG. 13, no additional capacitance may be needed. Of course, capacitor 111 could be supplemented with additional off chip capacitance, if so desired. The circuit configuration of FIG. 14 provides the similar power savings as previously discussed for the logic circuit 30 in FIG. 4, including savings due to the crowbar currents and the differential voltages ΔV.

However, in the embodiment shown in FIG. 14, the output buffers QBUF 117 operate directly off of the power supplies Vcc and Vss. It will be recalled that operation of circuitry between the pseudo power supplies PVcc and PVss results in some drifting of the values of PVcc and PVss during switching and as shown in FIGS. 5A and 5B. Thus, it may be desirable to operate the output buffer QBUF 117 from the power supplies Vcc and Vss in those applications where the output buffer 117 needs the full range of switching between the voltage supplies Vcc and Vss in order to interface with other circuitry that also operates between voltage supplies Vcc and Vss. If the full range of output voltage switching is not matched, crowbar currents may be generated in the interface circuitry or the interface circuitry may not switch properly. Thus, the embodiment of FIG. 14 with the output buffer 117 operating between voltage supplies Vcc and Vss is intended for those applications where the signals from the output buffer 117 need to interface with standard CMOS switching levels. Of course, if the next circuit that the output buffer 117 interfaces with also operates between pseudo power supplies PVcc and PVss, the output buffer 117 may also be configured to operate between pseudo voltage supplies PVcc and PVss, instead of between voltage supplies Vcc and Vss.

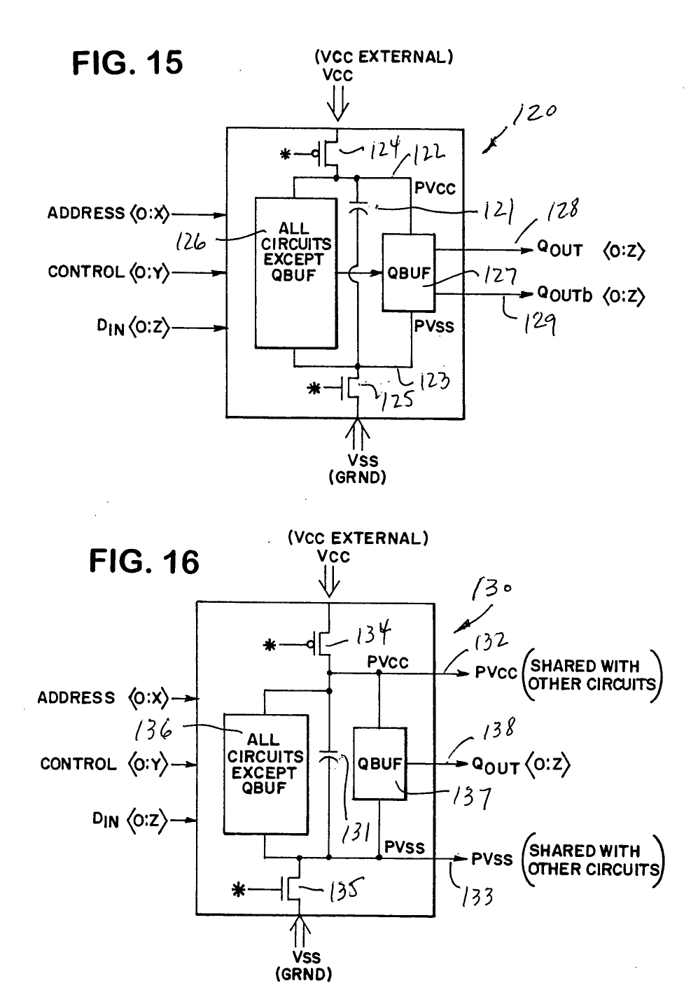

FIG. 15 illustrates a second embodiment of the present invention with respect to a memory circuit, generally designated 120. In this embodiment, output buffer QBUF 127 also operates between pseudo voltage supplies PVcc and PVss on pseudo voltage supply rails 122 and 123, respectively, and a capacitor 121. Thus, unlike memory circuit 110 of FIG. 14, the output buffer 127 of FIG. 15 also takes advantage of crowbar current power savings during switching. This is possible because the outputs Qout and Qoutb on output lines 128 and 129 of the output buffer 127 are differential. That is, when Qout is at a high level, Qoutb is at a low level. Such differential signals do not require full CMOS switching levels, as between supply voltages Vcc and Vss, in order to properly interface with additional circuitry. Only one of the signals Qout or Qoutb needs to be higher than the other signal. Such an interface for the output of buffer 127 requires that the next circuit also has the capability to handle differential signals. Many high speed memory circuits presently use such differential signaling. These high speed memory circuits can take advantage of the typically increased crowbar currents that occur at higher switching speeds with the present invention.

Yet another embodiment of the present invention, as applied to a memory circuit, generally designated 130, is shown in FIG. 16. In this embodiment, all of the circuitry, including output buffer QBUF 137, and a capacitor 131 operate between the pseudo voltage supplies PVcc and PVss on pseudo supply rails 132 and 133. However, unlike the embodiment of memory circuit 120 shown in FIG. 15, the outputs of buffer 137 on line 138 are not differential even though the output buffer 137 operates between supply voltages Vcc and Vss. This is because the pseudo supply voltages, PVcc and PVss, that are internally supplied to the memory circuit 130, are also passed on to, or provided to, the circuitry that buffer 137 interfaces with by means of external connections to pseudo supply rails 132 and 133. Thus, the circuitry that output buffer 137 interfaces with will operate between the same pseudo voltage levels, which will eliminate or substantially reduce interface issues. The additional pseudo supply voltage outputs, PVcc and PVss, provide for power savings in the output buffer 137 and further permit the output of output buffer 137 to be non-differential. Another advantage of memory circuit 130 in FIG. 16 is that fewer output signals need to be routed to the next circuit or chip. For example, an eight-output full-differential buffer 127 for memory circuit 120 in FIG. 15 would require 16 signals to be routed, i.e., Qout <0:7> and Qoutb <0:7>. In the memory circuit 130 of FIG. 16, only 10 signals need to be routed to the next chip, namely, Qout <0:7> and the pseudo power supplies PVcc and PVss. This results in a savings of six output lines for the memory circuit 130 in FIG. 16, as compared to memory circuit 120. Of course, the next circuit that the output buffer 137 will interface with will also require six fewer input lines as compared to memory circuit 120.

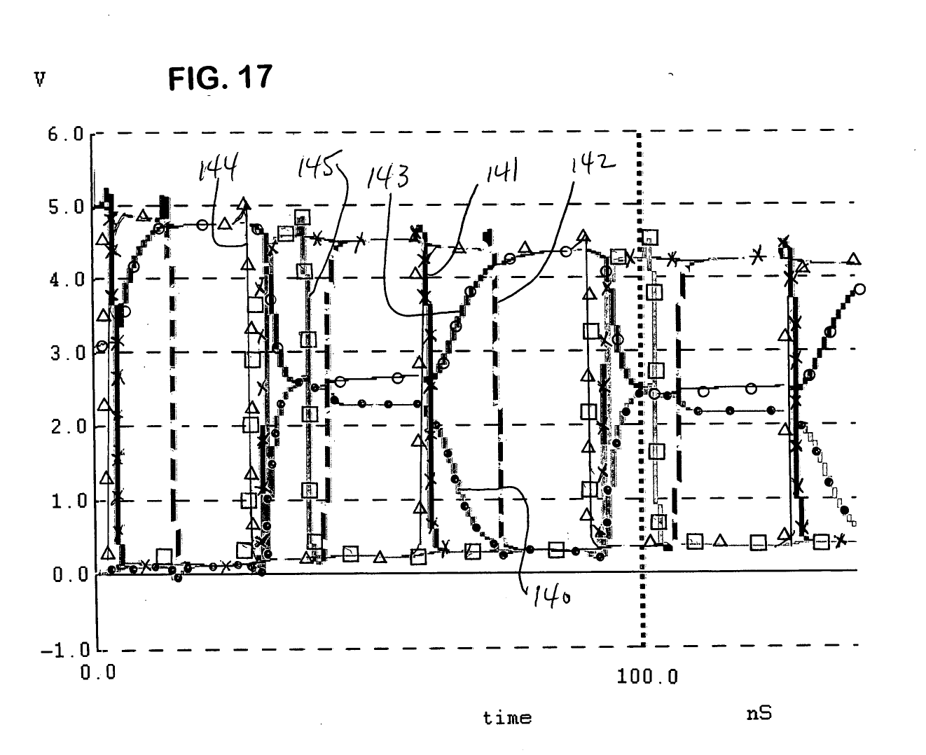

FIG. 17 is a graph illustrating typical voltage waveforms from a computer simulation of a typical memory cell within the memory circuits 110, 120 or 130 of FIGS. 14, 15 or 16, respectively when operating from the pseudo power supplies PVcc and PVss in accordance with the present invention. As is typical, multiple memory cells are arranged in large arrays with bit lines (BIT), bit bar lines (BTB), word lines (WORDL), sense amplifier lines (SA), sense bar amplifier lines (SAB) and precharge lines (PRE). In the example of FIG. 17, the BTB line is represented by voltage waveform 140 (identified by black dots), the SAB line is represented by voltage waveform 141 (identified by X's), the WORDL line is represented by voltage waveform 142 (identified by dashed lines), the BIT line is represented by voltage waveform 143 (identified by circles), the SA line is represented by voltage waveform 144 (identified by triangles) and the PRE line is represented by voltage waveform 145 (identified by squares). The signals associated with these various lines quickly decay toward the final values of the pseudo voltages PVcc and PVss of about 4.0 volts and 0.5 volts, respectively. Of course, if the teachings of the present invention are not utilized, the signals on these various lines will remain between Vss and Vcc, which are selected to be 5.0 and 0 volts, respectively, in this example.

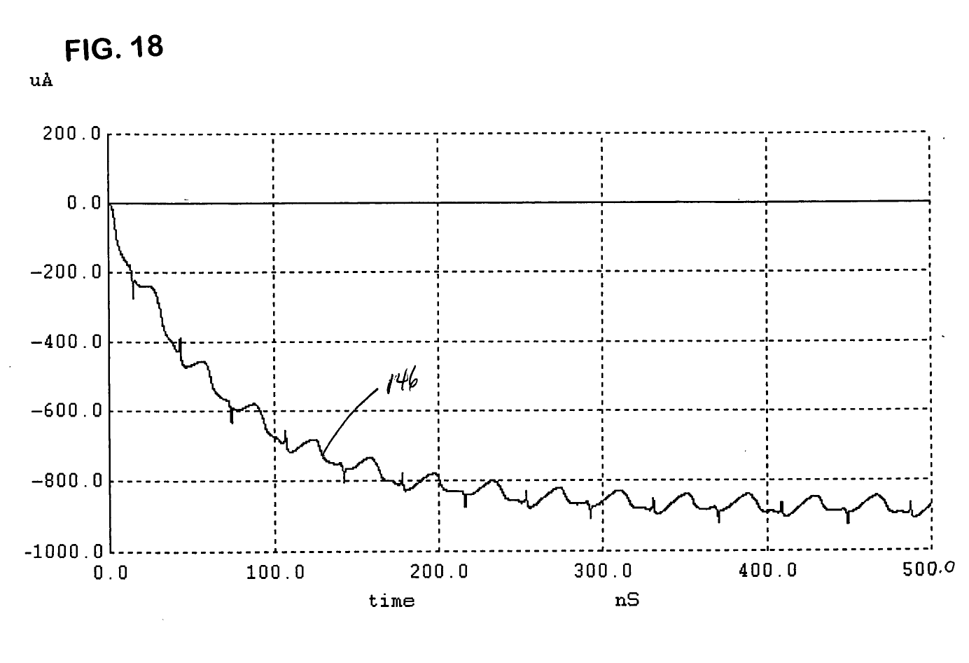

FIG. 18 illustrates a typical current drain waveform 146 for a typical memory cell within the memory circuit 110, 120 or 130 of FIGS. 14, 15 or 16, respectively, when operating from the pseudo power supplies PVcc and PVss in accordance with the present invention. The current quickly stabilizes at about 930 μA, with transients of about ±50 μA.

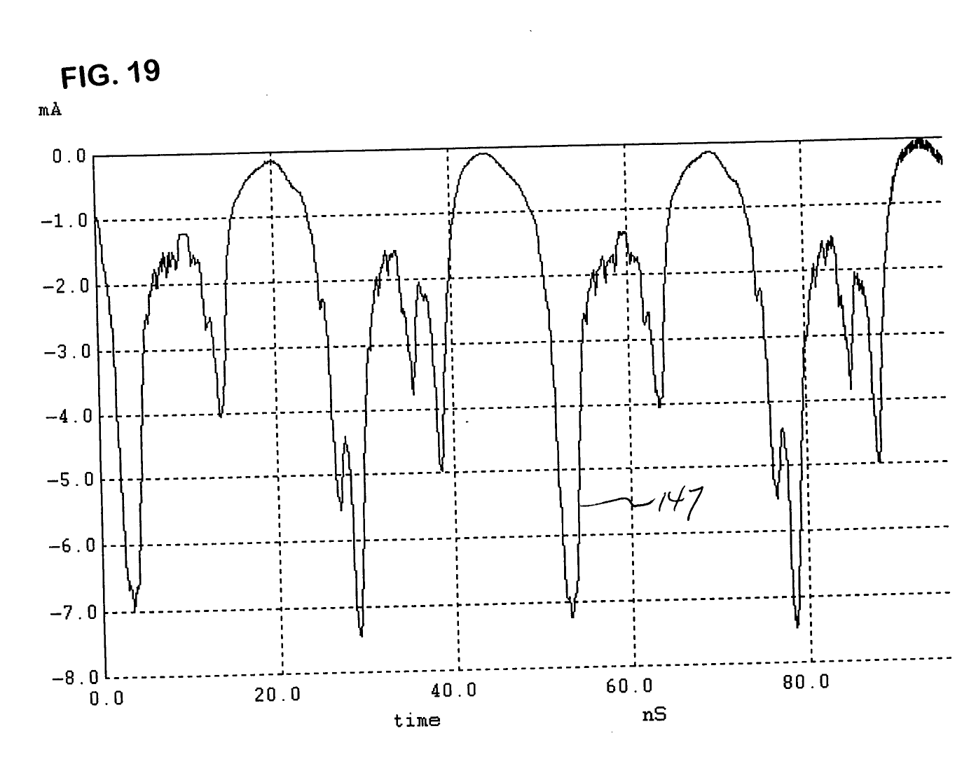

FIG. 19 illustrates typical current drain waveform 147 for a typical memory cell within the memory circuit 110, 120 or 130 of FIGS. 14, 15 or 16, respectively, when operating directly between a voltage supply Vcc and ground (or a negative voltage supply Vss). As can be appreciated, the current is in the form of transients between about 0 and slightly more than 7 mA. It can therefore be expected that the memory cell operating directly between the power supplies Vcc and Vss (or ground) will produce much more EMI than the corresponding memory cell operating between the pseudo power supplies PVcc and PVss. In this example, the current transients are approximately 100 μA to 7 mA different in peak-to-peak magnitude; for about a 1:70 ratio. That is, the peak-to-peak magnitude of the current signal for a memory cell without the present invention (FIG. 19) is about 70 times that of the current signal for a memory cell with the present invention (FIG. 18).

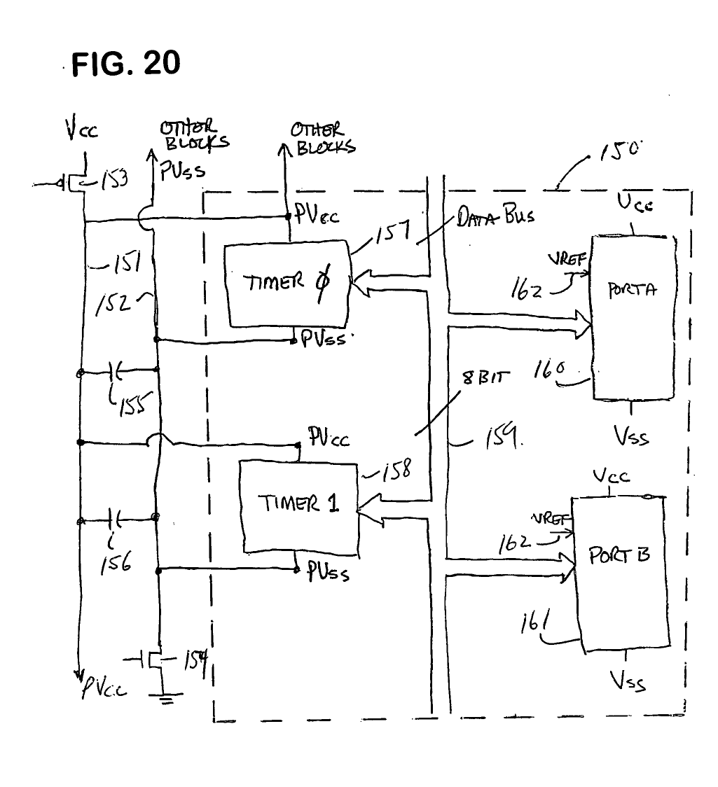

FIG. 20 illustrates a simplified microprocessor, generally designated 150, with certain portions of the microprocessor operating from the pseudo power supplies PVcc and PVss on pseudo power supply rails 151 and 152, respectively, in accordance with the present invention. As in prior embodiments, a first transistor or impedance 153 is disposed between power supply Vcc and pseudo power supply PVcc, a second transistor or impedance 154 is disposed between pseudo power supply PVss and power supply Vss (or ground) and at least one capacitor 155 is disposed between the pseudo power supply rails 151 and 152. Capacitor 155 may be on the microprocessor chip or external to the microprocessor 150. For example, capacitor 150 may be the order of several nanofarads to hundreds of nF. Capacitor 155 may be supplemented with additional capacitance, such as capacitor 156, also disposed between pseudo power supply rails 151-152, if desired.

In the simplified example of FIG. 20, pseudo power supplies PVcc and PVss are routed to other portions or blocks within microprocessor 150, such as to timer0 157 and timer1 158. However, it is preferable that numerous other blocks within microprocessor 150 also receive the benefits of power savings and noise reduction of the present invention. For example, other timers, internal memory, such as RAM, ROM and flash memory, counters, registers, encoders, decoders, multiplexers, arithmetic logic units, reset circuitry, interrupt circuitry and the like, may also be supplied from pseudo power supplies PVss and PVcc, as desired, or as appropriate in view of the particular microprocessor design. Of course, the long channel or bias of transistors 153-154 will need to be tuned or sized to satisfy the power requirements of those portions or blocks of microprocessor 150 that receive power from pseudo power supplies PVcc and PVss. Moreover, additional pseudo power supplies may be implemented to satisfy the power requirements certain portions or blocks of microprocessor 150, if desired or needed. While data bus 159 is indicated as 8 bits in FIG. 20, this is merely exemplary. The present invention also has application to microprocessors with data busses of other sizes, such as 16 bits, 32 bits, etc.

Output ports, PortA 160 and PortB 161, are shown in FIG. 20 as operating directly from power supplies Vcc and Vss rather than from pseudo power supplies PVcc and PVss. Such operation may be needed if the output ports need to interface with other CMOS circuitry that needs the full range of switching provided by power supplies Vcc and Vss. However, the output ports 160-161 of microprocessor may also operate from the pseudo power supplies PVcc and PVss if such output ports use differential signaling or if the circuitry that interfaces with such output ports also operates off of pseudo power supplies. Such operation would be analogous to that of output buffers 127 and 137 in FIGS. 15 and 16, as previously discussed with respect to memory circuits 120 and 130. Output ports 160-161 may also receive a reference voltage signal on a line 162 that is about one-half of the difference between the pseudo power supply voltages PVcc and PVss.

Depending upon the design and operation of the particular microprocessor, certain portions or blocks of the microprocessor may require operation from power supplies Vcc and Vss rather than from pseudo power supplies PVcc and PVss. For example, any analog circuitry, such as analog-to-digital converters, may require the full range of power supplies Vcc and Vss to avoid clipping or otherwise changing the analog signals. Similarly, certain clock or timing circuits may need the full range of power supplies Vss and Vcc to avoid adversely affecting the clock frequency or timing requirements. However, most of the microprocessor may still benefit from the advantages and teachings of the present invention.

The present invention can enhance the useful life or the time between recharging of batteries in battery-powered devices since the current drain by the internal electronics from the power supply or from the battery is substantially reduced. For example, extended battery life may be experienced in battery-powered laptop computers, cellular telephones, controllers or actuators for all kinds of apparatus including entertainment devices, pagers, portable music devices and players, portable radios, personal digital assistants (PDAs), and the like. Nevertheless, traditional AC-powered devices and appliances that utilize electronic circuitry can also benefit from increased power savings and reduced heat dissipation. Personal computers are one such example.

While particular embodiments of the invention have been shown and described, it will be apparent to those skilled in the art that changes and modifications may be made therein without departing from the invention in its broader aspects, and, therefore, the aim of the appended claims is to cover all such changes and modifications as fall within the true spirit and scope of the invention.

1. A power saving circuit for operation of electronic circuitry that is implemented in CMOS technology between a positive voltage supply and a negative voltage supply, said electronic circuitry having a positive voltage terminal and a negative voltage terminal, said power saving circuit comprising:
a first impedance disposed between the positive voltage supply and the positive voltage terminal of the electronic circuitry,
a second impedance disposed between the negative voltage supply and the negative voltage terminal of the electronic circuitry, and
a capacitor disposed between the positive voltage terminal and negative voltage terminal of the electronic circuitry, said electronic circuitry operating from a pseudo voltage supply across the capacitor.

2. The power saving circuit in accordance with claim 1 wherein high speed switching in the electronic circuitry produces switching currents that are recirculated to and from the capacitor to save power.

3. The power saving circuit in accordance with claim 1 wherein the negative voltage supply is a ground potential.

4. The power saving circuit in accordance with claim 1 wherein the first impedance comprises a first current source and the second impedance comprises a second current source.

5. The power saving circuit in accordance with claim 1 wherein the electronic circuitry comprises a memory circuit.

6. The power saving circuit in accordance with claim 1 wherein the electronic circuitry comprises a microprocessor.

7. The power saving circuit in accordance with claim 1 further comprising at least one transistor that may be activated to restore the voltage at the positive voltage terminal or at the negative voltage terminal of the electronic circuitry to the voltage of the first voltage supply or to the voltage of the second voltage supply, respectively.

8. A power saving circuit for operation between a positive voltage supply and negative voltage supply, said power saving circuit comprising:
electronic circuitry that is implemented in CMOS technology, said electronic circuitry having a positive voltage terminal and a negative voltage terminal,
a first impedance disposed between the positive voltage supply and the positive voltage terminal of the electronic circuitry,
a second impedance disposed between the negative voltage supply and the negative voltage terminal of the electronic circuitry, and
a capacitor disposed between the positive voltage terminal and the negative voltage terminal of the electronic circuitry, said electronic circuitry operating from a pseudo voltage supply across the capacitor.

9. The power saving circuit in accordance with claim 8 wherein high speed switching in the electronic circuitry produces switching currents that are recirculated to and from the capacitor to save power.

10. The power saving circuit in accordance with claim 8 wherein the negative voltage supply is a ground potential.

11. The power saving circuit in accordance with claim 8 wherein the first impedance comprises a first current source and the second impedance comprises a second current source.

12. The power saving circuit in accordance with claim 8 wherein the electronic circuitry comprises a memory circuit.

13. The power saving circuit in accordance with claim 8 wherein the electronic circuitry comprises a microprocessor.

14. The power saving circuit in accordance with claim 8 further comprising at least one transistor that may be activated to restore the voltage at the positive voltage terminal or at the negative voltage terminal of the electronic circuitry to the voltage of the first voltage supply or to the voltage of the second voltage supply, respectively.

15. A method of saving power by operating electronic circuitry that is implemented in CMOS technology from a pseudo voltage supply, said electronic circuitry having a positive voltage terminal and a negative voltage terminal, said method comprising the steps of:
providing a first impedance between a positive voltage supply and the positive voltage terminal of the electronic circuitry,
providing a second impedance between the negative voltage supply and the negative voltage terminal of the electronic circuitry, and
providing a capacitor between the positive voltage terminal and the negative voltage terminal of the electronic circuitry to establish a pseudo voltage supply for the electronic circuitry.

16. The method of saving power in accordance with claim 15 further comprising the step of:
recirculating high speed switching currents produced by the electronic circuitry to and from the capacitor to save power.

17. The method of saving power in accordance with claim 15 wherein the negative voltage supply is a ground potential.

18. A method of reducing electronic noise generated by high speed switching in electronic circuitry that is implemented in CMOS technology, said electronic circuitry having a positive voltage terminal and a negative voltage terminal, said method comprising the steps of:
providing a first impedance between a positive voltage supply and the positive voltage terminal of the electronic circuitry,
providing a second impedance between the negative voltage supply and the negative voltage terminal of the electronic circuitry, and
providing a capacitor between the positive voltage terminal and the negative voltage terminal of the electronic circuitry to establish a pseudo voltage supply for the electronic circuitry.

19. The method of reducing electronic noise in accordance with claim 18 wherein the electronic noise is reduced by a factor of at least 4 to 1.

20. The method of reducing electronic noise in accordance with claim 18 wherein the electronic noise is reduced by a factor greater than 10 to 1.

21. An electronic noise reduction circuit for operation between a positive voltage supply and a negative voltage supply, said electronic noise reduction circuit comprising:
electronic circuitry that is implemented in CMOS technology, said electronic circuitry having a positive voltage terminal and a negative voltage terminal,
a first impedance disposed between the positive voltage supply and the positive voltage terminal of the electronic circuitry,
a second impedance disposed between the negative voltage supply and the negative voltage terminal of the electronic circuitry, and
a capacitor disposed between the positive voltage terminal and the negative voltage terminal of the electronic circuitry,
said electronic circuitry operating from a pseudo voltage supply across the capacitor.

22. The electronic noise reduction circuit in accordance with claim 21 wherein the negative voltage supply is a ground potential.

23. The electronic noise reduction circuit in accordance with claim 21 wherein the first impedance comprises a first current source and the second impedance comprises a second current source.

24. The electronic noise reduction circuit in accordance with claim 21 wherein the electronic circuitry comprises a memory circuit.

25. The electronic noise reduction circuit in accordance with claim 21 wherein the electronic circuitry comprises a microprocessor.

26. The electronic noise reduction circuit in accordance with claim 21 wherein the electronic noise is reduced by a factor of at least 4 to 1.

27. The electronic noise reduction circuit in accordance with claim 21 wherein the electronic noise is reduced by a factor greater than 10 to 1.

28. In an integrated circuit, a method for supplying power to internal circuits within the integrated circuit, comprising the steps of:
providing first and second power supply nodes for first and second voltages respectively;
coupling a first supply voltage to said first supply node;
coupling a second supply voltage to said second supply node;
providing a capacitor between said first and second supply nodes;
coupling active circuits between said first and second supply nodes;
using voltage stored in said capacitor for driving said active circuits; and
capturing switching currents in said capacitor.

29. A method for supplying power to internal circuits in an integrated circuit, said method comprising the steps of:
providing first and second nodes for supplying first and second pseudo power supply voltages respectively;
selectively coupling a first supply voltage to said first supply node via a first supply control transistor;
selectively coupling a second supply voltage to said second supply node via a second supply control transistor;
connecting a capacitor between said first and second nodes;
coupling active circuits between said first and second nodes;
developing pseudo power supply voltages, at said capacitor and at said first and second nodes; and
using said pseudo power supply voltages to power said active circuits.

30. The method of claim 29 further comprising the additional step of:
powering an output buffer circuit via said first and second supply voltages.

31. The method of claim 29 further comprising the additional steps of:
receiving a Vcc voltage at a third node as said first supply voltage;
selectively coupling said third node to said first node by controlling a conductive path of said first control transistor;
receiving a Vss voltage at a fourth node as said second supply voltage; and
selectively coupling said fourth node to said second node by controlling a conductive path of said second control transistor.

32. A method for reducing power consumption in an integrated circuit, said method comprising the steps of:
using crowbar currents to charge a capacitor;
supplying voltage from said capacitor to active circuits in the integrated circuit; and
selectively charging said capacitor from a power source other than said active circuits.

33. A method for supplying power to internal circuits within an integrated circuit, said method comprising the steps of:
providing a power supply node for a first voltage;
coupling a first voltage to said power supply node;
providing a capacitor between said power supply node and ground or between said power supply node and a second voltage;
coupling active circuits between said power supply node and ground or between said power supply node and the second voltage;
using voltage stored in said capacitor for driving said active circuits; and
capturing switching currents in said capacitor.

34. A power saving circuit for operation of electronic circuitry that is implemented in CMOS technology between a positive voltage supply and a negative voltage supply, said electronic circuitry having a positive voltage terminal and a negative voltage terminal, said power saving circuit comprising:
an impedance disposed between the positive voltage supply and the positive voltage terminal of the electronic circuitry, and
a capacitor disposed between the positive voltage terminal of the electronic circuitry and the negative voltage supply, said electronic circuitry operating from a pseudo voltage supply across the capacitor.

35. The power saving circuit in accordance with claim 34 wherein the negative voltage supply is a ground potential.

36. The power saving circuit in accordance with claim 34 wherein the impedance comprises a current source.

37. The power saving circuit in accordance with claim 34 wherein the electronic circuitry comprises a memory circuit.

38. The power saving circuit in accordance with claim 34 wherein the electronic circuitry comprises a microprocessor.

39. The power saving circuit in accordance with claim 34 further comprising a transistor disposed in parallel with said impedance that may be activated to restore the voltage at the positive voltage terminal of the electronic circuitry to the voltage of the first voltage supply.

40. A power saving circuit for operation of electronic circuitry that is implemented in CMOS technology between a positive voltage supply and a negative voltage supply, said electronic circuitry having a positive voltage terminal and a negative voltage terminal, said power saving circuit comprising:
an impedance disposed between the negative voltage supply and the negative voltage terminal of the electronic circuitry, and
a capacitor disposed between the positive voltage supply and negative voltage terminal of the electronic circuitry, said electronic circuitry operating from a pseudo voltage supply across the capacitor.

41. The power saving circuit in accordance with claim 40 wherein the negative voltage supply is a ground potential.

42. The power saving circuit in accordance with claim 40 wherein the impedance comprises a current source.

43. The power saving circuit in accordance with claim 40 wherein the electronic circuitry comprises a memory circuit.

44. The power saving circuit in accordance with claim 40 wherein the electronic circuitry comprises a microprocessor.

45. The power saving circuit in accordance with claim 40 further comprising a transistor disposed in parallel with said impedance that may be activated to restore the voltage at the negative voltage terminal of the electronic circuitry to the voltage of the second voltage supply.
